(19) United States
(12) Patent Application Publication
(10) Pub. No.: US 2026/0152264 A1
(43) Pub. Date: Jun. 4, 2026

(54) VESSEL FOR PRODUCING HYDROGEN

(71) Applicant: LOUIS DREYFUS ARMATEURS, Suresnes (FR)

(72) Inventor: Thibault DROGUET, Suresnes (FR)

(21) Appl. No.: 19/113,487

(22) PCT Filed: Sep. 15, 2023
(86) PCT No.: PCT/EP2023/075381

§ 371 Date: Feb. 24, 2026

(30) Foreign Application Priority Data
Sep. 21, 2022 (FR) 2209528

(51) Int. Cl. B63B 35/44; C01B 3/047

(52) U.S. Cl. CPC B63B 35/44; C01B 3/047; B63B 2035/4473

(57) ABSTRACT

A vessel for hydrogen production includes a hydrogen production installation including a cracking assembly configured to crack a hydrogen-based compound to produce hydrogen and a cracking product, and a filtering and purification assembly configured to separate hydrogen from the cracking product.

### BACKGROUND

### Technical Field

The invention relates to a vessel intended for the production of hydrogen and to a method of producing hydrogen by a such vessel.

### Discussion of the Background

Major global governments and industries are increasingly committing to decarbonizing their economies and operations by around 2050.

This decarbonization thus leads to the use of alternative technologies for road, rail, maritime and air mobility. Alternatives such as battery-powered electric motors to replace combustion engines in vehicles are being used, for example.

However, the use of rechargeable batteries poses problems of autonomy and relatively long recharging times for vehicles.

Using fuel cells to power electric motors can improve the range of electric vehicles.

There are several types of fuel cells such as fuel cells that convert dihydrogen, commonly called hydrogen, methanol or ammonia into electricity.

A fuel cell is a generator in which electricity is produced by the oxidation on one electrode of a reducing fuel (for example dihydrogen) coupled with the reduction on the other electrode of an oxidant, such as dioxygen from the air.

Alternatively, it is also possible to use dihydrogen directly as fuel to power internal combustion engines of vessels or to decarbonise industrial processes, for example.

There is therefore a need for the production of hydrogen (or dihydrogen) and logistics for this hydrogen.

Traditionally, hydrogen is produced on land and transported by truck or through gas or pipelines. The pipeline is the means of transport traditionally used for distant destinations. For larger quantities and distant destinations, vessels are supplied through pipelines to transport hydrogen or hydrogen-based compounds to storage or distribution areas.

Green hydrogen will be available primarily in remote supply hubs such as Australia, Chile, Mauritania, Namibia, North Africa and the Middle East, where climatic and geographical conditions favour the cost-effective exploitation of renewable energy. On the other hand, the main centers of demand for hydrogen are in North America, Japan, North Korea and Western Europe.

Supply centers are thus sometimes very far from hydrogen demand centers.

In addition, hydrogen production is dangerous and is subject to strict standards.

Also known is document WO2019204857 which discloses an offshore hydrogen generation system comprising a platform fixed to the seabed or floating on the sea and anchored to the seabed. The platform is positioned close to the coast and includes a liquid ammonia storage tank which is supplied with ammonia by vessels. The platform also includes an ammonia cracking reactor to crack ammonia and produce hydrogen which is transported to shore via pipelines to supply hydrogen distributors or hydrogen users. Ammonia is also used to produce electricity which is also distributed on the coast to power charging stations.

The supply of ammonia by boat makes it possible to avoid the risks associated with this product, which is toxic in its gaseous state. The production of hydrogen at sea also makes it possible to avoid the risks associated with hydrogen and in particular to limit the damage in the event of an explosion on the platform.

However, sudden storms and bad weather conditions are becoming more frequent with global warming. The risk of the platform submerging is high, which can lead to serious damage to the platform or even an explosion of the platform. The material and human damage can be very significant.

In addition, the supply of hydrogen is strictly limited to hydrogen dispensers located near the platform, which is fixed. To supply other sites, it is necessary to fill trucks to transport the hydrogen to these remote sites, leading to risks of explosion on the road, or to transfer the hydrogen through gas pipelines, requiring heavy investments.

### BRIEF SUMMARY OF THE DESCRIPTION

The aim of the invention is therefore to overcome the drawbacks of the prior art by proposing a vessel for the production of hydrogen making it possible to secure the hydrogen production and storage installation against bad weather and to provide a more flexible supply of hydrogen, at different locations.

To this end, the invention thus relates, in its broadest sense, to a vessel for producing hydrogen.

According to the invention, the vessel comprises a hydrogen production installation including a cracking unit intended to crack a hydrogen-based compound to produce hydrogen and a cracking product. The vessel also includes a filtering and purification unit intended to separate hydrogen from the cracking product.

The invention thus provides a more flexible solution. The vessel is mobile, allowing it to move to sheltered ports in the event of a storm. The hydrogen production facility and the people on board are therefore protected and secure.

Hydrogen production is carried out in the open sea, which makes it possible to protect people and homes located on the coast in the event of an explosion or leak. Since ammonia is corrosive and toxic, it is more beneficial to store it offshore. Similarly, offshore hydrogen production significantly reduces danger zones for populations as well as the need for land.

In addition, the regulatory constraints are simplified because the standards for storing and producing hydrogen in land-based or maritime installations are different.

The vessel also allows the hydrogen production facility to be moved to supply storage or distribution areas located in different locations and far from each other.

The vessel can move to supply boats or industrial installations that are running out of ammonia or hydrogen for their propulsion, for example.

The vessel can move to refuel with ammonia at a location far away from the hydrogen delivery locations.

The invention avoids wasting time because the vessel produces hydrogen between its refueling point and its various delivery points, while consuming green energy, such as hydrogen or ammonia, for its propulsion.

It is possible to move the vessel if the need for hydrogen no longer exists at one location.

The vessel never sails empty, unlike prior art supply vessels which depart from a supply point to a delivery point filled with hydrogen-based compounds but return from the delivery point to the supply point empty. The vessel according to the invention is either loaded with a large quantity of ammonia ready to be transformed or loaded with a large quantity of hydrogen ready to be delivered.

It is possible to use several vessels to increase hydrogen production capacity.

The invention also eliminates the need for costly and environmentally unfriendly terminals in ports in highly constrained, populated and regulated areas.

According to one variant, the vessel comprises first storage means for storing the hydrogen-based compound, second storage means for storing the hydrogen and third storage means for storing the cracking product.

In another variant, the hydrogen-based compound is ammonia, the cracking product being nitrogen.

According to another variant, the filtering and purification assembly comprises a pressure inversion adsorption device.

According to another variant, the vessel comprises a deck and at least one hold. The cracking assembly, the filtering and purification assembly and the second storage means are positioned on the deck. The first storage means are positioned in the hold.

The advantage of positioning the cracking assembly, the filtering and purification assembly and the first storage means on deck is that it allows more space to be occupied than in the hold, provides better accessibility and allows any hydrogen leak to be evacuated more effectively. A gas explosion is also less devastating outside than inside the vessel.

According to another variant, the cracking assembly comprises several mobile cracking units and the filtering and purification assembly comprises several mobile filtering units.

According to another variant, the vessel comprises moving means for moving the mobile cracking units and the mobile filtering units.

The hydrogen production facility is therefore modular.

The means of movement make it possible to vary the number of mobile cracking units and mobile filtering units depending on the demand for hydrogen production.

Mobile cracking units and mobile filtering units may be moved by the moving means from a storage area to the hydrogen production facility to increase the hydrogen production capacity.

Mobile cracking units and mobile filter units can also be moved from the hydrogen production facility to a maintenance area to repair the mobile cracking units and mobile filter units.

The use of several mobile cracking units (or modules) in parallel makes production more reliable. A failed mobile cracking unit is immediately replaced by another mobile cracking unit.

The positioning of the cracking assembly and the filtering and purification assembly on the deck allows the use of more extensive means of movement and better mobility.

The invention also relates to a method for producing hydrogen by a vessel as defined above. The process includes: a step of supplying the vessel with hydrogen-based compound, a step of cracking the hydrogen-based compound by a cracking assembly to produce hydrogen and a cracking product, and a step of filtering to separate the hydrogen from the cracking product by a filtering and purification assembly.

In one embodiment, the mobile cracking units and mobile filter units are moved from a storage area to a hydrogen production facility to increase hydrogen production capacity.

### BRIEF DESCRIPTION OF THE DRAWINGS

Embodiments of the present invention will be described below, by way of non-limiting examples, with reference to the appended figures in which:

FIG. 1 schematically illustrates a hydrogen production vessel comprising a hydrogen production installation, according to one embodiment of the invention;

FIG. 2 schematically illustrates the vessel of the FIG. 1 in more detail;

FIG. 3 illustrates a diagram of a hydrogen production process by a vessel.

### DETAILED DESCRIPTION OF THE INVENTION

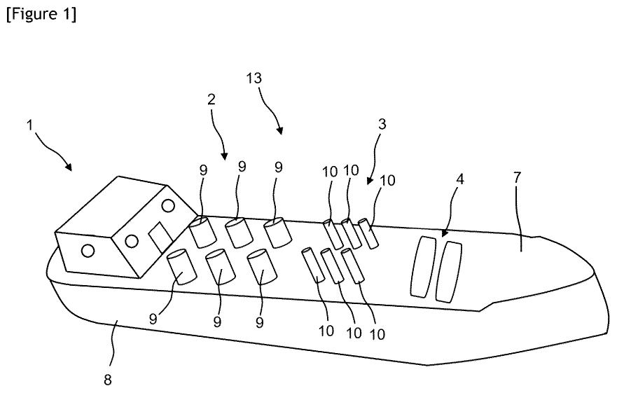

FIG. 1 illustrates a vessel 1 for the production of hydrogen comprising a hydrogen production installation 13 comprising a cracking assembly 2 intended to crack a hydrogen-based compound to produce hydrogen and a cracking product.

The hydrogen production facility 13 also includes a filtering and purification assembly 3 intended to separate the hydrogen from the cracking product.

A “vessel” means any type of floating and mobile nautical craft or structure, such as a boat, equipped with a propulsion system capable of moving on the sea or on a river.

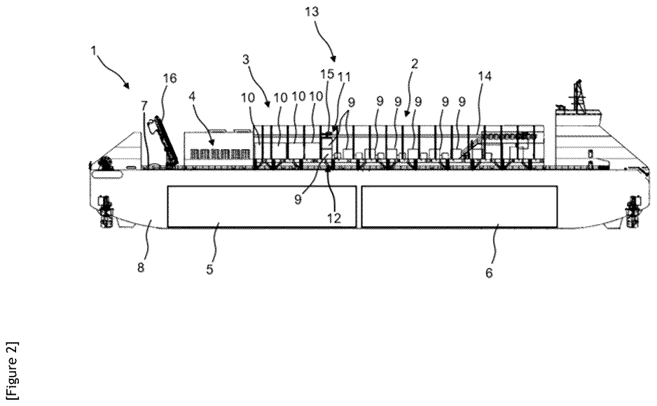

The vessel 1 comprises first storage means 4 for storing the hydrogen-based compound, second storage means 5 for storing the hydrogen and third storage means 6 for storing the cracking product, as illustrated in the FIG. 2.

The hydrogen-based compound can be in liquid or gaseous form.

The first, second and third storage means 4, 5, 6 may comprise one or more tanks for storing liquid or gas under pressure.

Preferably, the hydrogen-based compound is ammonia (NH₃), the cracking product being nitrogen.

The example given below is for ammonia but the hydrogen-based compound can be any compound that produces hydrogen after a cracking operation, such as methanol (CH₃OH) or methane (CH₄), for example.

Ammonia is stored in a liquid form at low temperatures (below −33° C.).

Cracking set 2 comprises several mobile cracking units 9, also called cracking reactors

The cracking operation is an endothermic reaction which consists of breaking ammonia into hydrogen (or dihydrogen). A catalyst is usually used in this well-known operation. The cracking process produces approximately 75% hydrogen and 25% nitrogen.

The filtering and purification assembly 3 comprises several mobile filtering units 10.

According to one variant, each mobile filtering unit 10 comprises a pressure inversion adsorption device. Pressure swing adsorption, also called pressure swing adsorption (PSA) (acronym for “Pressure Swing Adsorption”), is a process for separating gas mixtures in which the adsorption of a gas by a solid or liquid at a given pressure takes place alternately, followed by its desorption at a lower pressure. This process is also well known.

Other filtration systems are also possible, such as membrane separation or cryogenic separation, for example.

The mobile cracking units 9 are independent of each other and the mobile filtering units 10 are also independent of each other.

A mobile cracking unit 9 may be associated with a mobile filtering unit 10, for example, but other configurations are possible.

Vessel 1 comprises deck 7 and hold 8.

According to a possible embodiment, the cracking assembly 2, the filtering and purification assembly 3 and the second storage means 4 are positioned on the deck 7. The first storage means 5 and the third storage means 6 are positioned in the hold 8 or the cargo hold of the vessel 1. Other configurations are possible, such as second storage means 4 positioned in the hold 8 or the cargo hold, for example.

The hold is a closed compartment of a vessel, used to contain equipment, fuel to propel the vessel or provisions.

The hold is where a vessel's cargo is stored.

Storage in hold 8 is preferred to the cargo hold.

The advantage of positioning the cracking assembly 2, the filtering and purification assembly 3 and the first storage means 4 on deck 7 is to allow more space to be occupied, to have better accessibility and to allow more efficient evacuation of any possible hydrogen leak. A gas explosion is also less devastating outside than inside the vessel 1. Maintenance is also simplified and downtime is reduced.

Mobile cracking units 9 and mobile filtering units 10 are mobile on deck 7 of vessel 1.

The vessel 1 comprises moving means 11 for moving the mobile cracking units 9 and the mobile filtering units 10.

The moving means 11 may comprise one or more overhead cranes.

Each overhead crane comprises a rail 14 on which a lifting device 15 fitted with motors moves. The lifting device 15 is configured to lift a mobile cracking unit 9 or a mobile filtering unit 10 by means of cables operated by a first motor. The lifting device 15 translates along the rail 14 by means of a second motor.

Other means of movement 11 are possible, such as a crane for example.

The hydrogen production facility 13 is thus modular.

Mobile cracking units 9 and mobile filtering units 10 can be moved by the moving means 11 from a storage area 12 to the hydrogen production facility 13 to increase the hydrogen production capacity.

Mobile cracking units 9 and mobile filter units 10 may also be moved from the hydrogen production facility 13 to an onboard maintenance area to repair the mobile cracking units 9 and mobile filter units 10.

The size and production capacity of the hydrogen production facility 13 is thus modular.

Cracking is an endothermic reaction. The mobile cracking units 9 and the mobile filtering units 10 can be replaced by more efficient ones when a new generation of catalyst allows better performance.

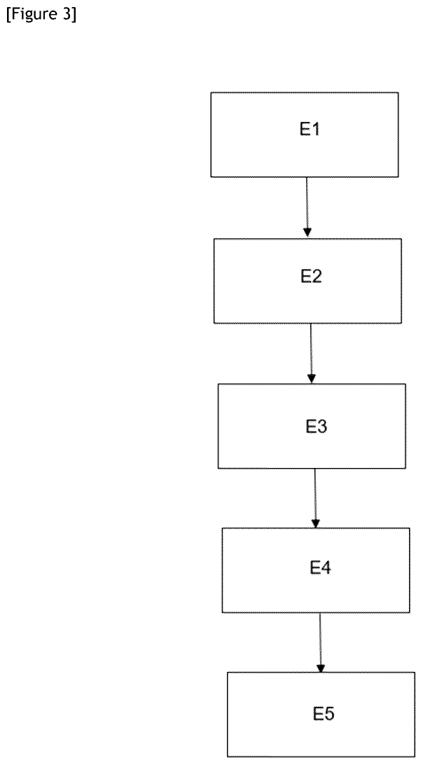

The invention also relates to a method for producing hydrogen by the vessel 1 described above. The process, illustrated by the diagram of the FIG. 3, comprises: a step of supplying E1 the vessel 1 with hydrogen-based compound, a step of cracking E2 of the hydrogen-based compound by a cracking assembly 2 to produce hydrogen and a cracking product, a step of filtering E3 to separate the hydrogen from the cracking product by a filtering and purification assembly 3, a step of storing E4 for hydrogen and cracking product, and a hydrogen distribution step E5.

Alternatively, the propulsion system of the vessel 1 may be powered by a hydrogen-based compound, such as ammonia, or by hydrogen.

Ammonia can be supplied to Vessel 1 by pipelines or by vessels.

Similarly, hydrogen can be distributed or exported on land by pipelines, containers, small vessels or other means to storage points in order to supply service stations to deliver hydrogen to vehicles, for example.

Alternatively, hydrogen can be distributed to other vessels travelling longer distances to supply more distant storage points.

Vessel 1 can also redistribute ammonia or hydrogen to another vessel to power its power system and propulsion system, for example.

The vessel 1 may comprise a loading arm 16 for bunkering hydrogen or hydrogen-based compound onto other vessels and also for supplying it with hydrogen-based compound.

Alternatively, the vessel 1 may be equipped with a docking bridge to accommodate small boats for unloading hydrogen containers into the boats or loading containers of hydrogen-based compounds onto the vessel 1, for example. This prevents dangerous vessel-to-vessel operations and transfer at the quayside by crane for example.

1. A vessel for producing hydrogen referring to any type of floating and mobile nautical craft or structure equipped with a propulsion system capable of moving on the sea or a river, the vessel comprising:
a hydrogen production installation including a cracking unit intended to crack a hydrogen-based compound to produce hydrogen and a cracking product; and
a filtering and purification unit intended to separate hydrogen from the cracking product, said ship comprising first storage means for storing the hydrogen-based compound, second storage means for storing the hydrogen, and third storage means for storing the cracking product.

2. The vessel according to claim 1, wherein the hydrogen-based compound is ammonia, and the cracking product being nitrogen.

3. The vessel according to claim 1, wherein the filtering and purification assembly comprises a pressure inversion adsorption device.

4. The vessel according to claim 1, further comprising a deck and at least one hold, the cracking assembly, the filtering and purification assembly and the second storage means being positioned on the deck, the first storage means being positioned in the hold.

5. The vessel according to claim 1, wherein the cracking assembly comprises several mobile cracking units, the filtering and purification assembly comprising several mobile filtering units.

6. The vessel according to claim 1, further comprising moving means for moving the mobile cracking units and the mobile filtering units.

7. The vessel according to claim 6, wherein the movement means comprise at least one overhead crane.

8. A method for producing hydrogen by a vessel as defined according to claim 1, the method comprising:
supplying the vessel with a hydrogen-based compound,
cracking of the hydrogen-based compound by a cracking assembly to produce hydrogen and a cracking product, and
filtering to separate the hydrogen from the cracking product by a filtering and purification assembly.

9. The method according to claim 8, wherein the cracking assembly comprises several mobile cracking units, the filtering and purification assembly comprises several mobile filtering units the mobile cracking units and the mobile filtering units being moved from a storage area to a hydrogen production plant to increase the hydrogen production capacity.
